(19) United States
(12) Patent Application Publication
(10) Pub. No.: US 2020/0271472 A1
(43) Pub. Date: Aug. 27, 2020

(54) METHOD FOR SELECTING TRAVEL ROUTES BASED ON USER-DEFINED ESSENTIAL POINTS OF INTEREST

(71) Applicant: Trip Routing Technologies, LLC, Hilton Head, SC (US)

(72) Inventor: Thomas T. BOUVE, Annapolis, MD (US)

(73) Assignee: Trip Routing Technologies, LLC, Hilton Head, SC (US)

(21) Appl. No.: 16/795,853

(22) Filed: Feb. 20, 2020

Related U.S. Application Data
(60) Provisional application No. 62/809,932, filed on Feb. 25, 2019.

(51) Int. Cl. G01C 21/34

(52) U.S. Cl. CPC G01C 21/3476

(57) ABSTRACT

A method may include receiving, by a navigation device, travel information identifying an origin and a destination. The method may include receiving, by the navigation device, user-defined point of interest (POI) information identifying a POI. The method may include determining, by the navigation device, route information identifying a set of routes between the origin and the destination, based on the travel information and the user-defined POI information. The method may include providing, by the navigation, the route information for display to permit a selection of a route from among the set of routes.

### CROSS-REFERENCE TO RELATED APPLICATION(S)

This application claims priority under 35 U.S.C. § 119 from U.S. Provisional Application No. 62/809,932 filed on Feb. 25, 2019 in the U.S. Patent & Trademark Office, the disclosure of which is incorporated herein by reference in its entirety.

### BACKGROUND

### 1. Field

The present disclosure is directed to the locations of points of interest (“POIs”) and navigation systems. In particular, the present disclosure focuses on POIs that provide services to road travelers and a method to evaluate and compare alternative routes to readily access them.

### 2. Description of Related Art

POIs for highway travel include the locations of services and products drivers may want along the journey, such as hotels, restaurants, gas stations, and stores of various kinds. In addition, the driver will periodically need public rest areas, and some will need special services at those rest areas deemed important, such as recreational vehicle (RV) dumping facilities or wireless fidelity (Wi-Fi) accessibility. Scenic vistas, county fairs, emergency facilities, such as hospitals and police stations, and other venues are also of interest to road travelers in varying degrees.

Navigation systems are commonly used to guide travelers to destinations. Such systems are available in-vehicle or free-standing, to be moved from vehicle to vehicle; for use by drivers; as applications on personal digital assistants, and as systems that are stand-alone or as systems that utilize a remote server platform to perform some or all of their calculations.

The common use of navigation systems is to provide the traveler to the destination with a defined route. The driver typically selects the destination by entering the address, or selects it from a list of destinations.

Traditionally, navigation systems identify the POIs that are near the defined travel route and provide directions and information about those facilities. Often the user can specify the off-route maximum distance to be considered.

### SUMMARY

An aspect of this disclosure is to provide a method for evaluating and selecting a travel route based on the en route placement of user-defined essential POIs. Essential POIs, such as public rest areas, hospitals, and police stations have a compelling utility to many road travelers. In addition, POIs such as rest areas, have specialized services, such as RV dump facilities or Wi-Fi access, which are desirable to drivers who are in need of such amenities, and prefer a public rest area rather than exiting the road that they are on to find such services. Still other drivers would prefer to choose a travel route that is in frequent vicinity to favorite commercial service establishments (such as a restaurant chain).

Adequate en route location of essential POIs along a travel route can be a deciding factor in determining the most preferred travel route from origin to destination. Further, the choice of a travel route depends not only on the type of POI deemed essential by the user, but upon personal tastes and desires as well. Considering the latter, two RV drivers, each with a need to choose a road with RV dumping services along the route, might choose different paths when considering the time need to reach the destination: important to one, but perhaps not so much so to the other.

Given a set of user-preferred (“essential”) POIs and an origin and destination, the present disclosure calculates quantitative and visual profiles of alternative routes and comparative accessibility and locations of essential POIs in proximity to those routes. These POIs are typically public rest areas with specified services, but could include other types of essential services, such as hospitals and police stations, thus, effectively, any POI deemed “essential” by the user, including scenic vistas or favored restaurant chain.

Quantitative elements of alternative route profiles include: driving distance and driving time, number of essential POIs along route, comparative statistics of POIs, and other factors. A major element in this disclosure is a map-based visual display of essential POIs along alternative routes, where much (POI placement and interval spacing, volume and frequency of towns and cities, the shape of the alternative routes, etc.) can be roughly ascertained with a simple glance.

It is understood that traditional navigation systems might be capable of identifying essential POIs all along the typical travel route, and the driver can search for essential POIs in real-time should a need arise. The assumption of the present disclosure is that many drivers would prefer to select a route that has more locations of the user's essential POIs along it, thus maximizing the likelihood that, when desired, one is nearby.

A system in accordance with the present disclosure includes a global positioning system (GPS) module, user interface module, database and routing engine. POI-Route profile data are prepared for each of the alternative routes, which are evaluated, along with map-based displays of the POI-routes, by the user.

According to some possible implementations, a method may include receiving, by a navigation device, travel information identifying an origin and a destination; receiving, by the navigation device, user-defined point of interest (POI) information identifying a POI; determining, by the navigation device, route information identifying a set of routes between the origin and the destination, based on the travel information and the user-defined POI information; and providing, by the navigation, the route information for display to permit a selection of a route from among the set of routes.

According to some possible implementations, a navigation device may include a memory configured to store instructions, and a processor configured to execute the instructions to receive travel information identifying an origin and a destination; receive user-defined point of interest (POI) information identifying a POI; determine route information identifying a set of routes between the origin and the destination, based on the travel information and the user-defined POI information; and provide the route information for display to permit a selection of a route from among the set of routes.

According to some possible implementations, a non-transitory computer-readable medium may store instructions, the instructions comprising: one or more instructions that, when executed by one or more processors of a navigation device, cause the one or more processors to receive travel information identifying an origin and a destination; receive user-defined point of interest (POI) information identifying a POI; determine route information identifying a set of routes between the origin and the destination, based on the travel information and the user-defined POI information; and provide the route information for display to permit a selection of a route from among the set of routes.

### BRIEF DESCRIPTION OF THE DRAWINGS

FIG. 1 is a diagram of an example environment in which systems and/or methods, described herein, may be implemented according to an embodiment;

FIG. 2 is a diagram of example components of one or more devices of FIG. 1 according to an embodiment;

FIG. 3 is a diagram of example components of a navigation device according to an embodiment;

FIG. 4 is a flowchart of an example process for providing route information based on travel information and user-defined point of interest (POI) information according to an embodiment;

FIGS. 5A-5E are diagrams of example user interface (UI) screens according to an embodiment; and

FIG. 6 is a diagram of an example process for selecting a route according to an embodiment.

### DETAILED DESCRIPTION

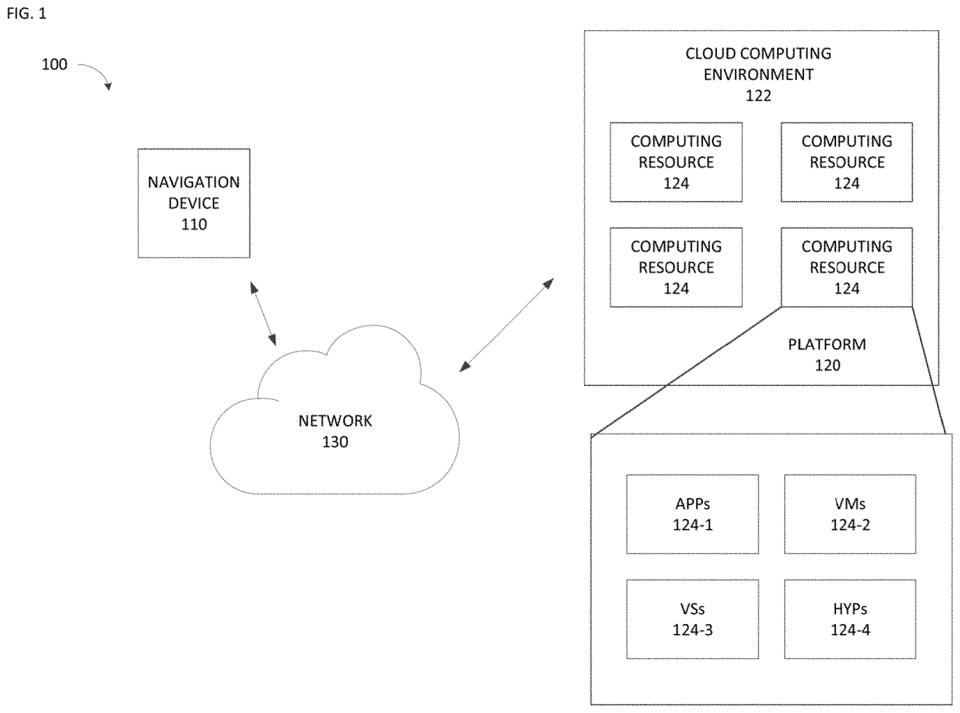

FIG. 1 is a diagram of an example environment 100 in which systems and/or methods, described herein, may be implemented. As shown in FIG. 1, environment 100 may include a navigation device 110, a platform 120, and a network 130. Devices of environment 100 may interconnect via wired connections, wireless connections, or a combination of wired and wireless connections.

Navigation device 110 includes one or more devices capable of receiving travel information identifying an origin and a destination; receiving user-defined point of interest (POI) information identifying a POI; determining route information identifying a set of routes between the origin and the destination, based on the travel information and the user-defined POI information; and providing the route information for display to permit a selection of a route from among the set of routes.

For example, navigation device 110 may include a computing device (e.g., an on-vehicle computer, a desktop computer, a laptop computer, a tablet computer, a handheld computer, a smart speaker, a server, etc.), a mobile phone (e.g., a smart phone, a radiotelephone, etc.), a wearable device (e.g., a pair of smart glasses or a smart watch), or a similar device. In some implementations, navigation device 110 may receive information from and/or transmit information to platform 120.

Platform 120 includes one or more devices capable of receiving travel information identifying an origin and a destination; receiving user-defined point of interest (POI) information identifying a POI; determining route information identifying a set of routes between the origin and the destination, based on the travel information and the user-defined POI information; and providing the route information to permit a selection of a route from among the set of routes as described elsewhere herein.

In some implementations, platform 120 may include a cloud server or a group of cloud servers. In some implementations, platform 120 may be designed to be modular such that certain software components may be swapped in or out depending on a particular need. As such, platform 220 may be easily and/or quickly reconfigured for different uses.

In some implementations, as shown, platform 120 may be hosted in cloud computing environment 122. Notably, while implementations described herein describe platform 120 as being hosted in cloud computing environment 122, in some implementations, platform 120 is not be cloud-based (i.e., may be implemented outside of a cloud computing environment) or may be partially cloud-based.

Cloud computing environment 122 includes an environment that hosts platform 120. Cloud computing environment 122 may provide computation, software, data access, storage, etc. services that do not require end-user (e.g., navigation device 110) knowledge of a physical location and configuration of system(s) and/or device(s) that hosts platform 120. As shown, cloud computing environment 122 may include a group of computing resources 124 (referred to collectively as “computing resources 124” and individually as “computing resource 124”).

Computing resource 124 includes one or more personal computers, workstation computers, server devices, or other types of computation and/or communication devices. In some implementations, computing resource 124 may host platform 120. The cloud resources may include compute instances executing in computing resource 124, storage devices provided in computing resource 124, data transfer devices provided by computing resource 124, etc. In some implementations, computing resource 124 may communicate with other computing resources 124 via wired connections, wireless connections, or a combination of wired and wireless connections.

As further shown in FIG. 1, computing resource 124 includes a group of cloud resources, such as one or more applications (“APPs”) 124-1, one or more virtual machines (“VMs”) 124-2, virtualized storage (“VSs”) 124-3, one or more hypervisors (“HYPs”) 124-4, or the like.

Application 124-1 includes one or more software applications that may be provided to or accessed by navigation device 110. Application 124-1 may eliminate a need to install and execute the software applications on navigation device 110. For example, application 124-1 may include software associated with platform 120 and/or any other software capable of being provided via cloud computing environment 122. In some implementations, one application 124-1 may send/receive information to/from one or more other applications 124-1, via virtual machine 124-2.

Virtual machine 124-2 includes a software implementation of a machine (e.g., a computer) that executes programs like a physical machine. Virtual machine 124-2 may be either a system virtual machine or a process virtual machine, depending upon use and degree of correspondence to any real machine by virtual machine 124-2. A system virtual machine may provide a complete system platform that supports execution of a complete operating system (“OS”). A process virtual machine may execute a single program, and may support a single process. In some implementations, virtual machine 124-2 may execute on behalf of a user (e.g., navigation device 110), and may manage infrastructure of cloud computing environment 122, such as data management, synchronization, or long-duration data transfers.

Virtualized storage 124-3 includes one or more storage systems and/or one or more devices that use virtualization techniques within the storage systems or devices of computing resource 124. In some implementations, within the context of a storage system, types of virtualizations may include block virtualization and file virtualization. Block virtualization may refer to abstraction (or separation) of logical storage from physical storage so that the storage system may be accessed without regard to physical storage or heterogeneous structure. The separation may permit administrators of the storage system flexibility in how the administrators manage storage for end users. File virtualization may eliminate dependencies between data accessed at a file level and a location where files are physically stored. This may enable optimization of storage use, server consolidation, and/or performance of non-disruptive file migrations.

Hypervisor 124-4 may provide hardware virtualization techniques that allow multiple operating systems (e.g., “guest operating systems”) to execute concurrently on a host computer, such as computing resource 124. Hypervisor 124-4 may present a virtual operating platform to the guest operating systems, and may manage the execution of the guest operating systems. Multiple instances of a variety of operating systems may share virtualized hardware resources.

Network 130 includes one or more wired and/or wireless networks. For example, network 130 may include a cellular network (e.g., a fifth generation (5G) network, a long-term evolution (LTE) network, a third generation (3G) network, a code division multiple access (CDMA) network, etc.), a satellite network, a public land mobile network (PLMN), a local area network (LAN), a wide area network (WAN), a metropolitan area network (MAN), a telephone network (e.g., the Public Switched Telephone Network (PSTN)), a private network, an ad hoc network, an intranet, the Internet, a fiber optic-based network, or the like, and/or a combination of these or other types of networks.

The number and arrangement of devices and networks shown in FIG. 1 are provided as an example. In practice, there may be additional devices and/or networks, fewer devices and/or networks, different devices and/or networks, or differently arranged devices and/or networks than those shown in FIG. 1. Furthermore, two or more devices shown in FIG. 1 may be implemented within a single device, or a single device shown in FIG. 1 may be implemented as multiple, distributed devices. Additionally, or alternatively, a set of devices (e.g., one or more devices) of environment 100 may perform one or more functions described as being performed by another set of devices of environment 100.

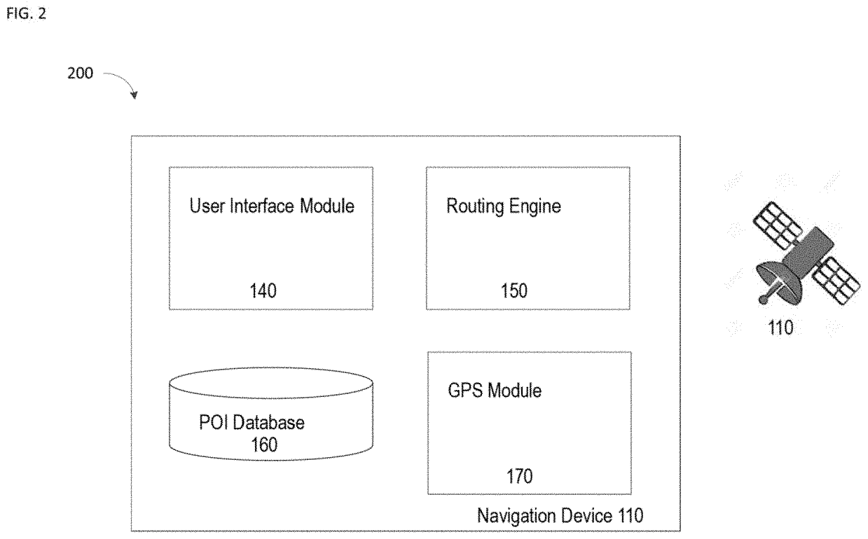

FIG. 2 is a diagram of a system 200 in accordance with an embodiment of the present disclosure. System 200 includes a navigation device 110 including a user interface (UI) module 140, a routing engine 150, a POI database 160, and a GPS module 170, and includes a satellite 210.

UI module 140 provides one or more screens of information and enables the user (e.g., driver, passenger, etc.) to communicate with the navigation device 110. Routing engine 150 manages route planning and guidance functions. POI database 160 provides local storage for the navigation device 110 and information about POIs and other features such as roads, intersections, terrain, etc. GPS module 180 performs GPS location functions and receives GPS signals from GPS satellites 110. Note that although in the described embodiment the navigation device 110 uses GPS to determine its location, alternative technology may be used, particularly as newer technology is developed. The present disclosure is equally applicable regardless of the manner in which the navigation device 110 derives its location.

User interface module 140 provides many of the user interface functions conventionally available on personal navigation devices. For example, UI module 140 allows a user to specify a destination, or both origin and destination by entering addresses, or selecting from a list. In addition, UI module 140 in various embodiments of the present disclosure includes interface elements for receiving POIs and alternative route map display preferences from a driver, and for presenting search results and routing information.

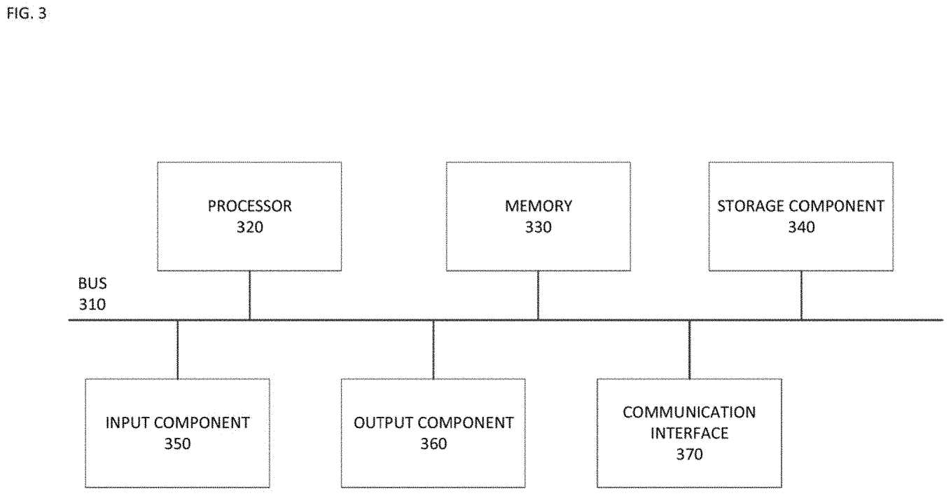

FIG. 3 is a diagram of example components of a device 300. Device 300 may correspond to navigation device 110 and/or platform 120. Further, device 300 may correspond to user interface (UI) module 140, routing engine 150, POI database 160, and GPS module 170. As shown in FIG. 3, device 300 may include a bus 310, a processor 320, a memory 330, a storage component 340, an input component 350, an output component 360, and a communication interface 370.

Bus 310 includes a component that permits communication among the components of device 300. Processor 320 is implemented in hardware, firmware, or a combination of hardware and software. Processor 320 is a central processing unit (CPU), a graphics processing unit (GPU), an accelerated processing unit (APU), a microprocessor, a microcontroller, a digital signal processor (DSP), a field-programmable gate array (FPGA), an application-specific integrated circuit (ASIC), or another type of processing component. In some implementations, processor 320 includes one or more processors capable of being programmed to perform a function. Memory 330 includes a random access memory (RAM), a read only memory (ROM), and/or another type of dynamic or static storage device (e.g., a flash memory, a magnetic memory, and/or an optical memory) that stores information and/or instructions for use by processor 320.

Storage component 340 stores information and/or software related to the operation and use of device 300. For example, storage component 340 may include a hard disk (e.g., a magnetic disk, an optical disk, a magneto-optic disk, and/or a solid state disk), a compact disc (CD), a digital versatile disc (DVD), a floppy disk, a cartridge, a magnetic tape, and/or another type of non-transitory computer-readable medium, along with a corresponding drive.

Input component 350 includes a component that permits device 300 to receive information, such as via user input (e.g., a touch screen display, a keyboard, a keypad, a mouse, a button, a switch, and/or a microphone). Additionally, or alternatively, input component 350 may include a sensor for sensing information (e.g., a global positioning system (GPS) component, an accelerometer, a gyroscope, and/or an actuator). Output component 360 includes a component that provides output information from device 300 (e.g., a display, a speaker, and/or one or more light-emitting diodes (LEDs)).

Communication interface 370 includes a transceiver-like component (e.g., a transceiver and/or a separate receiver and transmitter) that enables device 300 to communicate with other devices, such as via a wired connection, a wireless connection, or a combination of wired and wireless connections. Communication interface 370 may permit device 300 to receive information from another device and/or provide information to another device. For example, communication interface 370 may include an Ethernet interface, an optical interface, a coaxial interface, an infrared interface, a radio frequency (RF) interface, a universal serial bus (USB) interface, a Wi-Fi interface, a cellular network interface, or the like.

Device 300 may perform one or more processes described herein. Device 300 may perform these processes in response to processor 320 executing software instructions stored by a non-transitory computer-readable medium, such as memory 330 and/or storage component 340. A computer-readable medium is defined herein as a non-transitory memory device. A memory device includes memory space within a single physical storage device or memory space spread across multiple physical storage devices.

Software instructions may be read into memory 330 and/or storage component 340 from another computer-readable medium or from another device via communication interface 370. When executed, software instructions stored in memory 330 and/or storage component 340 may cause processor 320 to perform one or more processes described herein.

Additionally, or alternatively, hardwired circuitry may be used in place of or in combination with software instructions to perform one or more processes described herein. Thus, implementations described herein are not limited to any specific combination of hardware circuitry and software.

The number and arrangement of components shown in FIG. 3 are provided as an example. In practice, device 300 may include additional components, fewer components, different components, or differently arranged components than those shown in FIG. 3. Additionally, or alternatively, a set of components (e.g., one or more components) of device 300 may perform one or more functions described as being performed by another set of components of device 300.

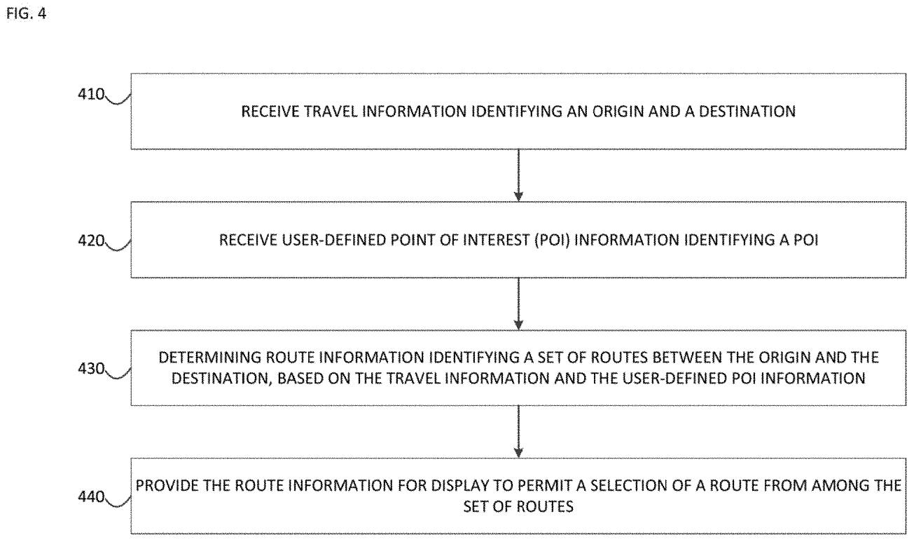

FIG. 4 is a flow chart of an example process 400 for providing route information based on travel information and user-defined POI information. In some implementations, one or more process blocks of FIG. 4 may be performed by navigation device 110. In some implementations, one or more process blocks of FIG. 4 may be performed by another device or a group of devices separate from or including navigation device 110, such as platform 120.

As shown in FIG. 4, process 400 may include receiving, by a navigation device, travel information identifying an origin and a destination (block 410).

The navigation device 110 may receive, based on a user input, travel information that identifies an origin (e.g., a start of a trip, a current location of the vehicle, or the like) and a destination (e.g., an intended destination of the trip, or the like). For example, assume that a driver plans to set out on a lengthy road trip from St. Louis, Mo. to Richmond, Va. In this case, the user may input St. Louis, Mo. as an origin, and Richmond, Va. as a destination.

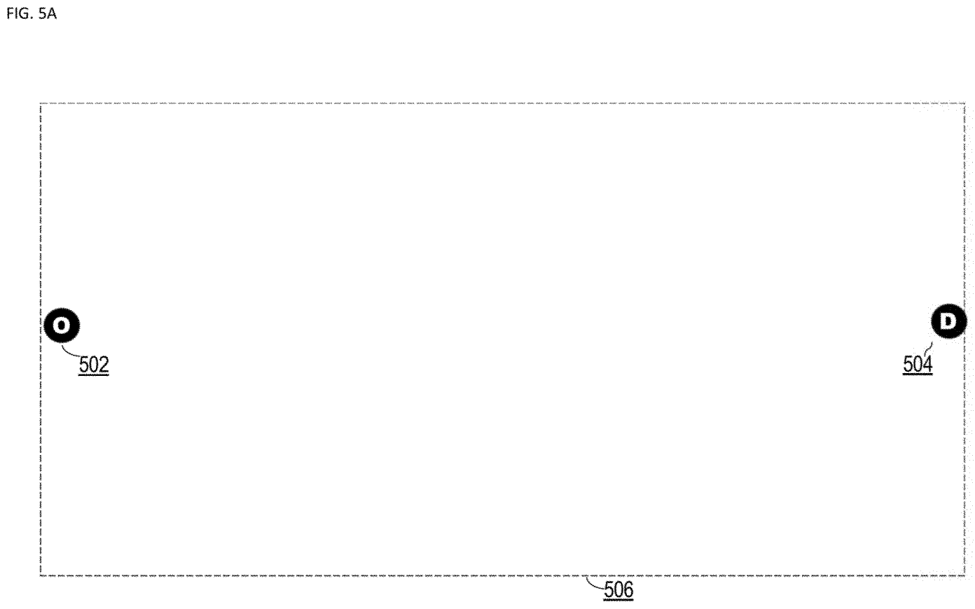

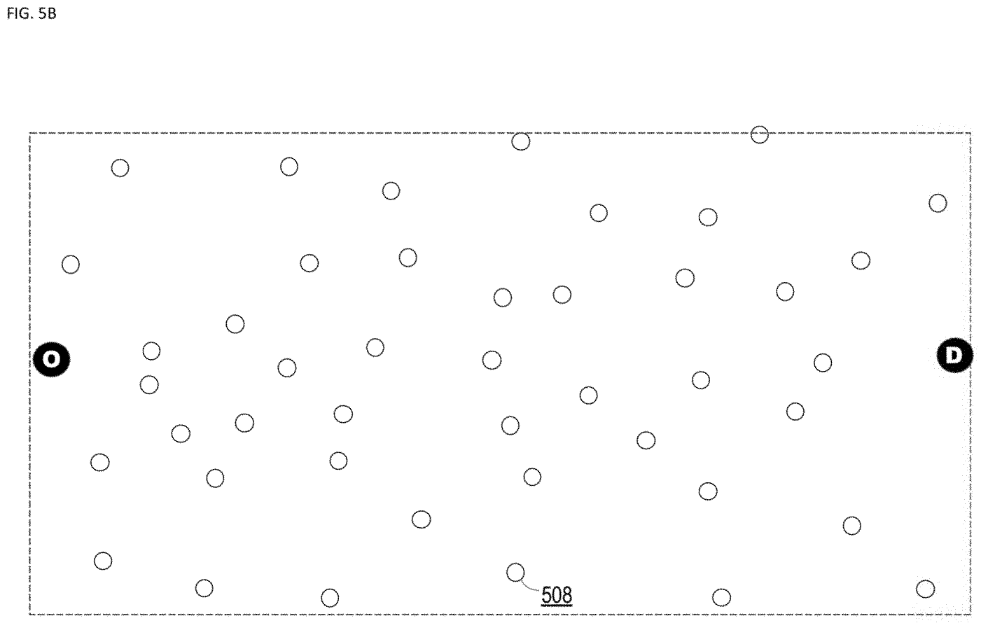

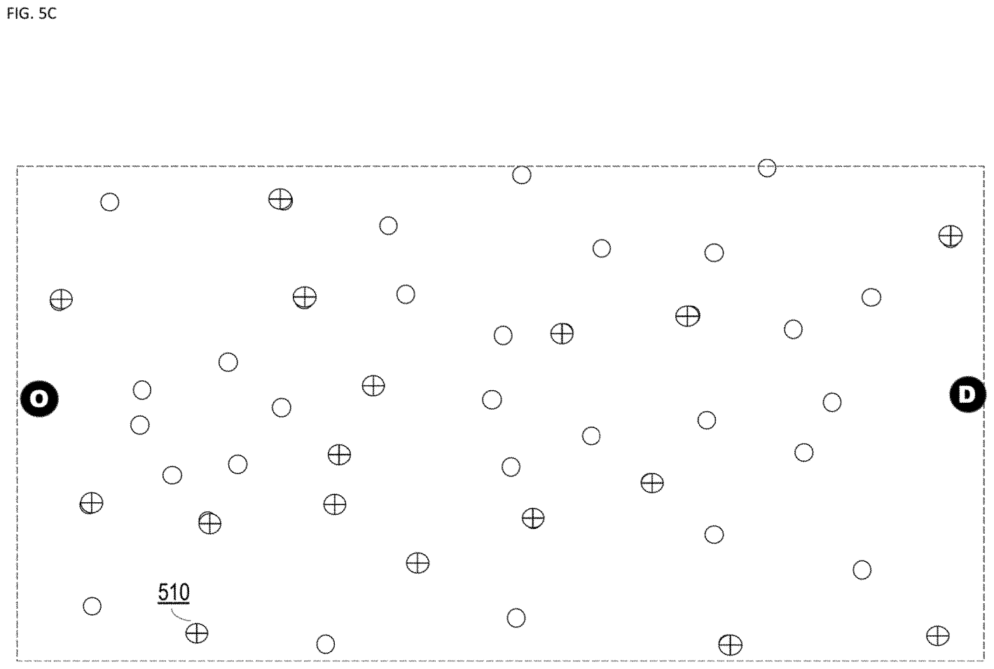

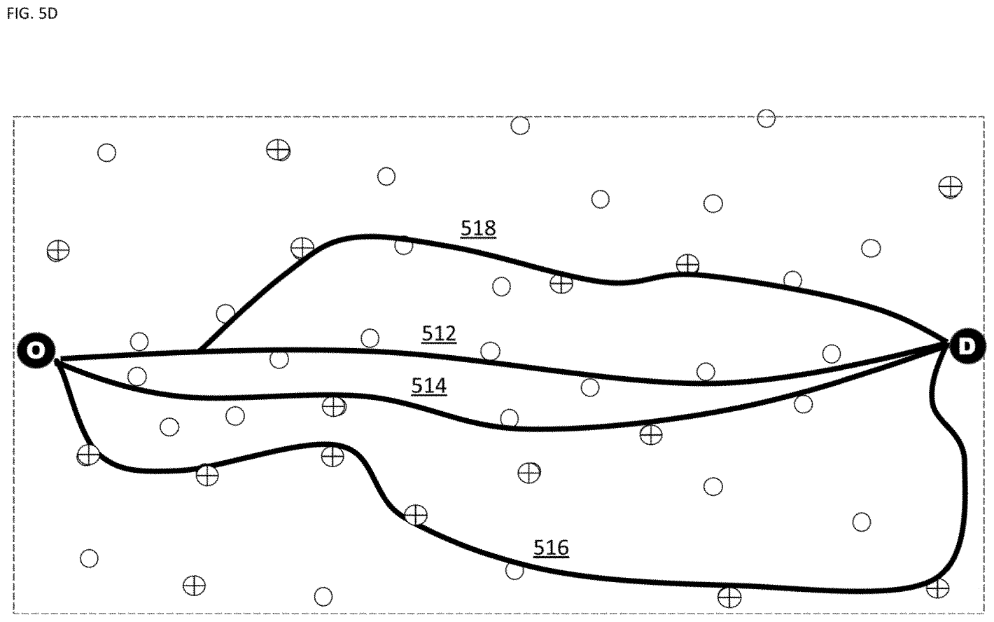

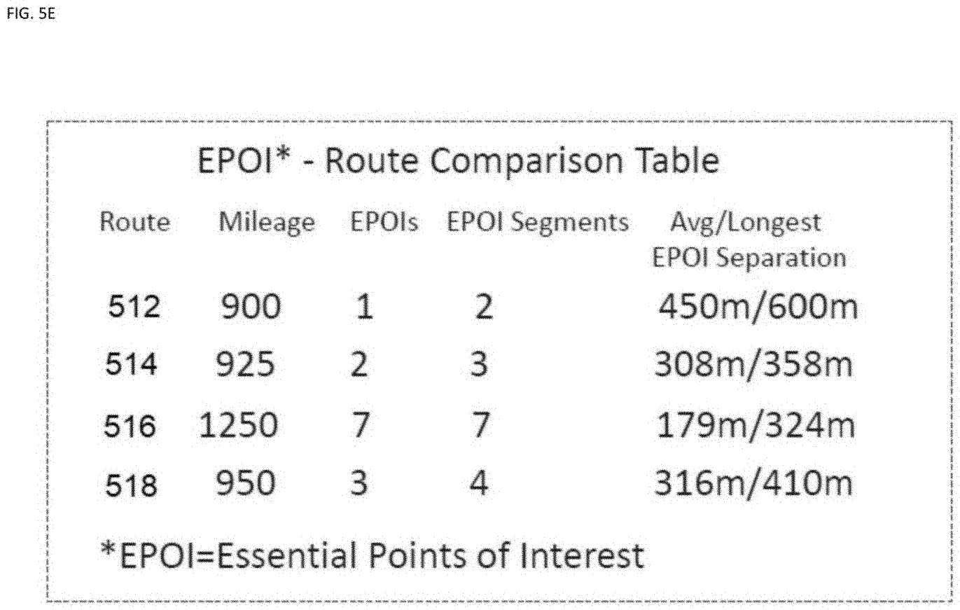

FIG. 5A illustrates an embodiment of a user interface module 140 creating POI search area 506 defined by the origin 502 and destination 504. The navigation device 110 provides an optional display of search area 506.

As further shown in FIG. 4, process 400 may include receiving, by the navigation device, user-defined point of interest (POI) information identifying a POI (block 420).

The navigation device 110 may receive, based on a user input, user-defined POI information identifying a POI.

The user-defined information may identify a POI. For example, the user-defined POI information may identify a particular POI, such as a particular rest area, attraction, shop, store, or the like. Additionally, or alternatively, the user-defined POI information may identify a type of POI, such as a type of rest areas, a type of stores, a type of attraction, police stations, hospitals, or the like. Additionally, or alternatively, the user-defined POI information may identify a service associated with a POI, such as a cleaning service, a vehicle charging service, or the like.

Additionally, or alternatively, the user-defined POI information may identify a set of different POIs, a set of different types of POIs, a set of different services of POIs, or the like. Further, the user-defined POI information may identify a preference, a priority, an importance, a rating, etc. of the respective POIs, types of POIs, services of the POIs.

The user-defined POI information may identify a threshold distance of a POI from a route. For example, the threshold distance may be 1 mile from the route, 5 miles, etc. Additionally, or alternatively, the user-defined POI information may identify a threshold distance between POIs. For example, the threshold distance may be 5 miles between rest stops, 100 miles between charging stations, etc. Additionally, or alternatively, the user-defined POI information may identify a threshold rating, cost, status, or the like, associated with a POI. For example, the threshold rating may be 3-star for hotels, 80% positive for restaurants, or the like.

FIG. 5B illustrates an embodiment of a user interface module 140 searching rest stop locations in search area 506 defined by the origin 502 and destination 504. The navigation device 110 provides an optional display of searched POIs, as represented by 508.

FIG. 5C illustrates an embodiment of a user interface module 140 searching rest stop locations in search area 506 defined by the origin 502 and destination 504. The navigation device 110 provides an optional display of searched essential POIs, as represented by 510. For example, the essential POIs 510 may correspond to rest stops that include RV sanitation services.

As further shown in FIG. 4, process 400 may include determining, by the navigation device, route information identifying a set of routes between the origin and the destination, based on the travel information and the user-defined POI information (block 430).

The navigation device 110 may determine route information identifying a set of routes based on the travel information and the user-defined POI information.

The navigation device 110 may determine a route that extends between the origin and destination, and that satisfies one or more predetermined criteria. For example, the predetermined criteria may be a threshold number of POIs matching the input POI being disposed along the route. As another example, the predetermined criteria may be a threshold distance of POI(s) from the route. As another example, the predetermined criteria may be a threshold distance of the route. As another example, the predetermined criteria may be a threshold duration of the route. As another example, the predetermined criteria may be a particular type of roadway(s). As another example, the predetermined criteria may be a threshold number of POI segments. A POI segment may refer to a route segment that extends between two different POIs. As another example, the predetermined criteria may be a threshold distance between POIs along the route. As another example, the predetermined criteria may be a maximum distance between POIs along the route. As another example, the predetermined criteria may be a frequency of POIs along the route. As another example, the predetermined criteria may be a score, rating, popularity, etc. of POIs along the route. As another example, the predetermined criteria may be a threshold number of different types of POIs being disposed along the route.

The navigation device 110 may determine a route that satisfies the predetermined criteria based on the travel information and the user-defined POI information, and may determine route information for the route.

For example, the route information may include a respective distance of each route of the set of routes. As another example, the route information may include a respective number of POIs, matching the POI, along each route of the set of routes. As another example, the route information may include a respective number of POI segments of each route of the set of routes. As another example, the route information may include a respective average distance between POIs, matching the POI, along each route of the set of routes. As another example, the route information may include a maximum distance between POIs, matching the POI, along each route of the set of routes.

The navigation device 110 may determine a threshold number of routes that satisfy the predetermined criteria (e.g., the top five routes, the top ten routes, etc.), and may provide the route information as described below.

As further shown in FIG. 4, process 400 may include providing, by the navigation, the route information for display to permit a selection of a route from among the set of routes (block 440).

The navigation device 110 may provide, for display, the route information to permit the user to select a particular route for which navigation information is to be generated.

FIG. 5D illustrates an embodiment of a routing engine 150 plotting multiple routes 512, 514, 516, and 518 from origin 502 to destination 504. The navigation device 110 offers the driver a display of searched essential POIs, non-essential POIs and routes 512, 514, 516, and 518.

FIG. 5E illustrates an embodiment of a user interface module 140 calculating tabular attributes of routes 512, 514, 516, and 518, including route distance, essential rest stop frequency, and placement information.

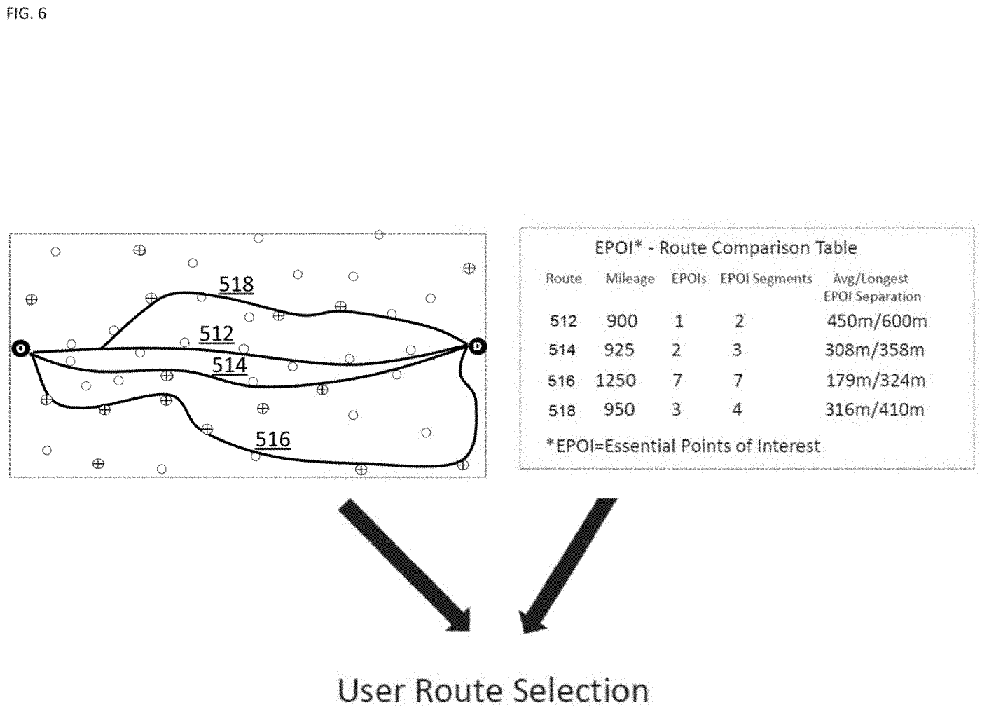

FIG. 6 represents an embodiment of the analytic process of inspection and evaluation of both mapping display as shown in FIG. 5D and tabular display as shown in FIG. 5E, and a subsequent user-selected route. It should be noted that the mapping display shown in FIG. 5D and the tabular display shown in FIG. 5E each provide useful information to the user in the POI-route selection process.

In an embodiment and referring to FIGS. 5D and 5E, route 512 would be chosen by a user who has a low level of need to have essential POIs in proximity to the route, and a greater need to get to the destination as soon as possible, hence the shortest route distance. This would typically be the route that is offered to all users. This user's selection of essential POIs could be rest stops that offer electric recharging stations, and the placement of the POI along the route is relatively inconsequential, particularly should the vehicle be able to travel the total distance on a single charge. Should the charge of the vehicle not be sufficient, then the placement of the charging station to recharge along the route becomes a selection factor.

In an embodiment and referring to FIGS. 5D and 5E, route 514 would be chosen by a user who has a need to have multiple placement and reasonable spacing of essential POIs along the route, without a significant driving time delay. Such a route with regular intervals of rest stops offering pet-friendly would have significant appeal.

In another embodiment and referring to FIGS. 5D and 5E, route 416 would be chosen by a user who has a desire to drive by multiple scenic vistas along to the route, driving distance being a negligible factor. Scenic vistas would be the essential POI category.

In another embodiment and referring to FIGS. 5D and 5E, route 518 would be chosen by a user who has a need to have regular POI placement along to the route, such as an RV driver with a need for periodic RV dumping facilities.

In other embodiments, the definition of “essential POI” itself can vary, depending upon the actual and perceived needs of the driver. For illustration, a user with a serious medical condition driving on a road trip to his doctor, may feel more emotionally comfortable on a route that has more hospitals along it, even if it is not the shortest route. In contrast, another user may define “essential POI” as a favorite restaurant chain, thereby selecting a travel route that has more locations of that commercial establishment.

The navigation device 110 may receive a selection of a route, and provide navigation information associated with the selected route.

Although FIG. 4 shows example blocks of process 400, in some implementations, process 400 may include additional blocks, fewer blocks, different blocks, or differently arranged blocks than those depicted in FIG. 4. Additionally, or alternatively, two or more of the blocks of process 400 may be performed in parallel.

The foregoing disclosure provides illustration and description, but is not intended to be exhaustive or to limit the implementations to the precise form disclosed. Modifications and variations are possible in light of the above disclosure or may be acquired from practice of the implementations.

As used herein, the term component is intended to be broadly construed as hardware, firmware, or a combination of hardware and software.

It will be apparent that systems and/or methods, described herein, may be implemented in different forms of hardware, firmware, or a combination of hardware and software. The actual specialized control hardware or software code used to implement these systems and/or methods is not limiting of the implementations. Thus, the operation and behavior of the systems and/or methods were described herein without reference to specific software code—it being understood that software and hardware may be designed to implement the systems and/or methods based on the description herein.

Even though particular combinations of features are disclosed in the specification, these combinations are not intended to limit the disclosure of possible implementations. In fact, many of these features may be combined in ways not specifically disclosed in the specification. Although each dependent claim listed below may directly depend on only one claim, the disclosure of possible implementations includes each dependent claim in combination with every other claim in the claim set.

No element, act, or instruction used herein should be construed as critical or essential unless explicitly described as such. Also, as used herein, the articles “a” and “an” are intended to include one or more items, and may be used interchangeably with “one or more.” Furthermore, as used herein, the term “set” is intended to include one or more items (e.g., related items, unrelated items, a combination of related and unrelated items, etc.), and may be used interchangeably with “one or more.” Where only one item is intended, the term “one” or similar language is used. Also, as used herein, the terms “has,” “have,” “having,” or the like are intended to be open-ended terms. Further, the phrase “based on” is intended to mean “based, at least in part, on” unless explicitly stated otherwise.

What is claimed is:

1. A method, comprising:
receiving, by a navigation device, travel information identifying an origin and a destination;
receiving, by the navigation device, user-defined point of interest (POI) information identifying a POI;
determining, by the navigation device, route information identifying a set of routes between the origin and the destination, based on the travel information and the user-defined POI information; and
providing, by the navigation, the route information for display to permit a selection of a route from among the set of routes.

2. The method of claim 1, wherein the route information includes a respective distance of each route of the set of routes.

3. The method of claim 1, wherein the route information includes a respective number of POIs, matching the POI, along each route of the set of routes.

4. The method of claim 1, wherein the route information includes a respective number of POI segments of each route of the set of routes.

5. The method of claim 1, wherein the route information includes a respective average distance between POIs, matching the POI, along each route of the set of routes.

6. The method of claim 1, wherein the route information includes a maximum distance between POIs, matching the POI, along each route of the set of routes.

7. The method of claim 1, further comprising:
receiving, by the navigation device, the selection of the route; and
providing, by the navigation device, navigation information associated with the selected route.

8. A navigation device, comprising:
a memory configured to store instructions; and
a processor configured to execute the instructions to:
receive travel information identifying an origin and a destination;
receive user-defined point of interest (POI) information identifying a POI;
determine route information identifying a set of routes between the origin and the destination, based on the travel information and the user-defined POI information; and
provide the route information for display to permit a selection of a route from among the set of routes.

9. The navigation device of claim 8, wherein the route information includes a respective distance of each route of the set of routes.

10. The navigation device of claim 8, wherein the route information includes a respective number of POIs, matching the POI, along each route of the set of routes.

11. The navigation device of claim 8, wherein the route information includes a respective number of POI segments of each route of the set of routes.

12. The navigation device of claim 8, wherein the route information includes a respective average distance between POIs, matching the POI, along each route of the set of routes.

13. The navigation device of claim 8, wherein the route information includes a maximum distance between POIs, matching the POI, along each route of the set of routes.

14. The navigation device of claim 8, wherein the one or more processors are further configured to:
receive the selection of the route; and
provide navigation information associated with the selected route.

15. A non-transitory computer-readable medium storing instructions, the instructions comprising: one or more instructions that, when executed by one or more processors of a navigation device, cause the one or more processors to:
receive travel information identifying an origin and a destination;
receive user-defined point of interest (POI) information identifying a POI;
determine route information identifying a set of routes between the origin and the destination, based on the travel information and the user-defined POI information; and
provide the route information for display to permit a selection of a route from among the set of routes.

16. The non-transitory computer-readable medium of claim 15, wherein the route information includes a respective distance of each route of the set of routes.

17. The non-transitory computer-readable medium of claim 15, wherein the route information includes a respective number of POIs, matching the POI, along each route of the set of routes.

18. The non-transitory computer-readable medium of claim 15, wherein the route information includes a respective number of POI segments of each route of the set of routes.

19. The non-transitory computer-readable medium of claim 15, wherein the route information includes a respective average distance between POIs, matching the POI, along each route of the set of routes.

20. The non-transitory computer-readable medium of claim 15, wherein the route information includes a maximum distance between POIs, matching the POI, along each route of the set of routes.
